(19) United States
(12) Patent Application Publication
(10) Pub. No.: US 2005/0205309 A1
(43) Pub. Date: Sep. 22, 2005

(54) Electronic balance

(75) Inventors: Atsushi Iiduka, Toyonaka (JP); Kunio Shimauchi, Kyoto (JP)

Correspondence Address: HAUPTMAN KANESAKA BERNER PATENT AGENTS, SUITE 300, 1700 DIAGONAL RD, ALEXANDRIA, VA, 22314-2848, US

(73) Assignee: SHIMADZU CORPORATION, Kyoto (JP)

(21) Appl. No.: 11/078,365

(22) Filed: Mar. 14, 2005

(30) Foreign Application Priority Data
Mar. 22, 2004 (JP) 2004-083016

(51) Int. Cl. G01G 23/10

(52) U.S. Cl. 177/185; 177/210 EM; 177/212

(57) ABSTRACT

An electronic balance includes a load transmission mechanism for receiving an object to be measured, a magnetic field generator having a force coil for generating magnetic field, and a balance beam connected at one end to the load transmission mechanism and disposed adjacent to the magnetic field generator with a fulcrum interposed between a portion connected to the weight section and the magnetic field generator. An electromagnetic force generated by supplying current to the force coil is applied to the balance beam to obtain a weight of the object from the current flowing through the force coil in equilibrium with the load. A damper is attached to the balance beam to control vibration in at least one of a longitudinal direction of the balance beam and a horizontal direction perpendicularly intersecting therewith.

### BACKGROUND OF THE INVENTION AND RELATED ART STATEMENT

The present invention relates to an electromagnetic force balancing type electronic balance that measures weight of a load by balancing the load with electromagnetic force imparted to a balance beam, with a fulcrum interposed therebetween, and particularly relates to an electronic balance having short fulcrum intervals or a high-precision electronic balance.

FIG. 6 depicts a conventional electromagnetic force balancing type electronic balance. This electronic balance is provided with a load transmission mechanism 1, which is composed of two beam members 14, 15 and a movable column 16 that transmits the load of an object 12 to be weighed placed on a weighing pan 11 in a vertical direction; a balance beam 26, one end of which is connected to said movable column 16 and the other end being provided with a force coil 25 generating electromagnetic force when control current flows through suspended therefrom, fulcrum 21 being disposed therebetween; and a load balancing mechanism 2, which is composed of a position sensor 27 detecting the degree of balance of the balance beam 26 and a PID control unit 28 outputting control current to achieve the balance. The control current in a balanced state is proportional to the load placed on the pan. The aforementioned control current is converted into voltage by a DC resistor 31 connected to the aforementioned force coil 15 in series, and a weight measurement corresponding to the load placed on the pan is calculated by using arithmetic expressions stored in advance in a display unit 3 and displayed (for example, see patent reference 1).

In the electronic balance described above, fluctuations in weight measurements that occur when the object is placed on the pan can be swiftly damped down through effective use of the derivative action (D action) of the PID control unit 28, and the fluctuations in the weight measurements caused when external vibration in the vertical direction is transmitted to the aforementioned balance beam 26 can be eliminated by electrical processing by using a low-pass filter or the like. However, the electronic balance is known to generate errors in weight measurements in the case such that the balance beam 26 cannot establish a balance because the balance beam 26 is brought into a horizontal level. A method to solve this problem is disclosed in patent reference 2.
Patent reference 1: Japanese Patent Publication (KOKAI) No. 2003-214932
Patent reference 2: Japanese Patent Publication (KOKAI) No. H10-104045

In the conventional electromagnetic force balancing type electronic balance constructed as above, when external vibration caused by environmental conditions in its surroundings is transmitted to the electronic balance, the balance beam 26 that balances, across fulcrum 21, the load with electromagnetic force resulting from the control current that is fed back vibrates. This vibration causes fluctuations in weight measurements. In this case, since the upward and downward movements of the balance beam 26 are symmetrical with reference to the level position with respect to the vibration in the vertical direction, the fluctuations in weight measurements can be eliminated relatively easily by means of a filtering process or the like performed in the display unit 3. However, since position control is not applied with respect to vibration occurring longitudinally along the balance beam 26 or horizontally intersecting perpendicularly therewith, the balance beam 26 also shakes due to external vibration in the directions other than the gravitational direction. This causes problems, such as reduced stability in weight measurements and poor response.

The present invention has been made in view of such situations, and an object of the invention is to provide an electronic balance in which the impact of external vibration transmitted in the horizontal direction is reduced.

Further objects and advantages of the invention will be apparent from the following description of the invention.

### SUMMARY OF THE INVENTION

To achieve the aforementioned objective, the electronic balance according to the present invention is comprised of a balance beam to which electromagnetic force generated by supplying current to a force coil positioned in the magnetic field of a permanent magnet and the load of an object to be weighed are applied across a fulcrum interposed therebetween to obtain weight of the object from the current flowing through the force coil generating electromagnetic force in equilibrium with the load. The electronic balance is provided with a magnet damper or air damper to control vibration in the longitudinal direction of the balance beam or in the horizontal direction perpendicularly intersecting therewith, or both.

The electronic balance of the present invention is constructed as above, and when vibration imparted longitudinally along the balance beam, or horizontally intersecting perpendicularly with the longitudinal vibration, is transmitted to the balance beam, the braking force of the magnet damper or the air damper counteracts such vibration. As a result, the balance beam quickly stops swaying, reducing the vibration and eliminating the impact on the weight measurement.

The electronic balance according to the present invention is provided with the magnet damper or air damper, thereby ensuring stable measurement at a high rate of response even in a location where external vibration imparted longitudinally along the balance beam, or horizontally intersecting perpendicularly with the longitudinal vibration, is transmitted to the balance beam, the position control for which has been absent in the conventional balance.

### BRIEF DESCRIPTION OF THE DRAWINGS

FIG. 1 is a schematic view of the electronic balance in one embodiment of the present invention;

FIG. 2(a) is a plan view showing the construction of a balance beam in the embodiment, and FIG. 2(b) is a side view thereof;

FIG. 3(a) is a plan view showing the construction of a magnet damper in the embodiment, and FIG. 3(b) is a side view thereof;

FIG. 4(a) is a plan view showing the construction of the balance beam in the embodiment, and FIG. 4(b) is a front view thereof;

FIG. 5(a) is a plan view showing the construction of air dampers, in the embodiment, and FIG. 5(b) is a sectional view taken along line 5(b)-5(b) in FIG. 5(a); and

FIG. 6 is a schematic view of a conventional electronic balance.

### DETAILED DESCRIPTION OF PREFERRED EMBODIMENTS

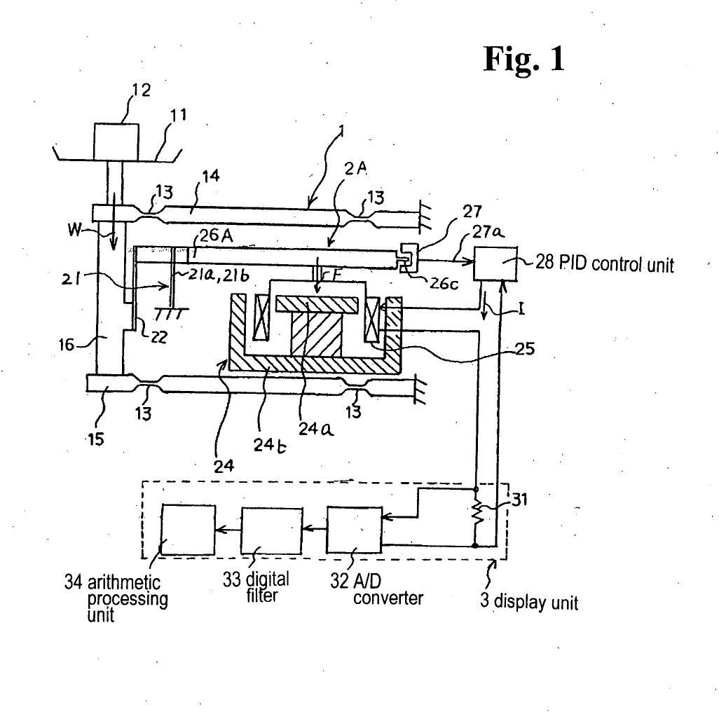

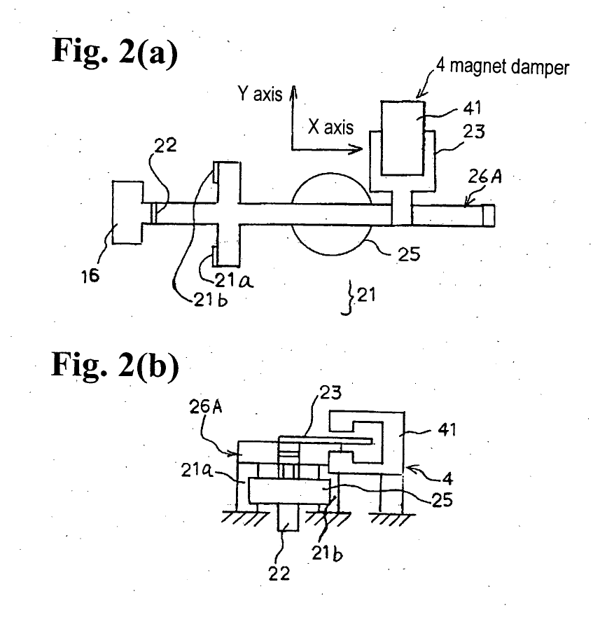

In the following, the electronic balance according to the present invention will be explained in detail by referring to an embodiment. FIG. 1 is a schematic view illustrating the construction of the electronic balance according to the present invention, FIG. 2(a) is a plan view depicting the construction of a balance beam 26A in the embodiment, and FIG. 2(b) is a side view of the same.

The electronic balance according to the present invention is constructed in the same manner as a conventional electronic balance with respect to the components other than the balance beam 26A depicted in FIGS. 2(a) and 2(b).

In other words, the electronic balance in this embodiment is comprised of a load transmission mechanism 1, which transmits the load placed on the pan W of the object 12 to be weighed and placed on weighing pan 11 as a vertical load; a load balancing mechanism 2, which balances the aforementioned load placed on the pan W transmitted via the load transmission mechanism 1 with electromagnetic force F described below; and a display unit 3, which carries out arithmetic processing by using control current I generating the aforementioned electromagnetic force F as an input and displays the weight measurement of the object 12 to be weighed (hereinafter simply referred to as measurement).

The aforementioned load transmission mechanism 1, as shown in FIG. 1, forms the Roberval mechanism by connecting one end of two beam members 14 and 15 provided in parallel, each having thin walled sections 13 formed with a certain interval interposed therebetween, to the upper and lower sections of a movable column 16, respectively, and fixing the other end of the beam members. Accordingly, when a load placed on the pan W is imparted to the movable column 16, the movable column 16 moves in a vertical direction, transmitting load placed on the pan W in a vertical direction.

The aforementioned load balancing mechanism 2A, as shown in FIGS. 2(a) and 2(b), is comprised of the following: a balance beam 26A, which is provided with fulcrum 21 movably supported by spring members 21a and 21b, that is connected to the movable column 16 via a connecting member 22 on one end and provided with a conductive plate 23 made of aluminum or the like in the vicinity of the other end, and further provided with a force coil 25 suspended therefrom in the agnetic field with flux density. B created by a magnetic field generator 24; a position sensor 27, which detects the position of an end section 26c of the aforementioned balance beam 26A; and a PID control unit 28, which compares a position signal 27a detected by the position sensor 27 with the internal target value and amplifies the deflection signal obtained to output control current I to which PID action has been added to make the deflection signal 0.

The aforementioned PID control unit 28 controls so as to balance the load placed on the pan W with the angular moment of electromagnetic force F. Assuming that the distances from fulcrum 21 of the balance beam 26A to the application points of the load placed on the pan W and electromagnetic force F are L_{1 and L}₂, respectively, and the length of the force coil 25 is L, the load placed on the pan W is proportional to control current I, as shown in the following formula (1):
W=KBL(L₂/L₁)I (1)

Moreover, the aforementioned display unit 3 is comprised of a resistor 31 that is connected to the aforementioned force coil 15 in series, an A/D converter 32 that converts the voltage generated by the control current I flowing through the resistor 31 into digital values, a digital filter 33 that smoothes out the variations in the converted digital values, and an arithmetic processing unit 34 that converts the smoothed digital values into a measurement value through arithmetic processing and displays the measurement on a liquid crystal display screen or the like.

Moreover, in the electronic balance according to the present invention, in order to reduce fluctuations and offset errors in measurements caused by external vibration in a given direction transmitted to the balance beam 26A, the conductive plate 23 is fixed on the balance beam 26A, as shown in FIGS. 2(a) and 2(b), and, at the same time, there is provided a magnet damper 4, which combines a permanent magnet with a magnetic field generator 41 made of a magnetic material. Assuming that the longitudinal direction of the balance beam 26A is the X axis, the horizontal direction that perpendicularly intersects with the X axis is the Y axis, and the vertical direction is the Z axis (omitted in the figure), the force of vibration transmitted from the given direction can be broken down into components in X-, Y-, and Z-axis directions. The aforementioned magnet damper 4 works to apply control to the X- and Y-axis vibration components of the aforementioned balance beam 26A.

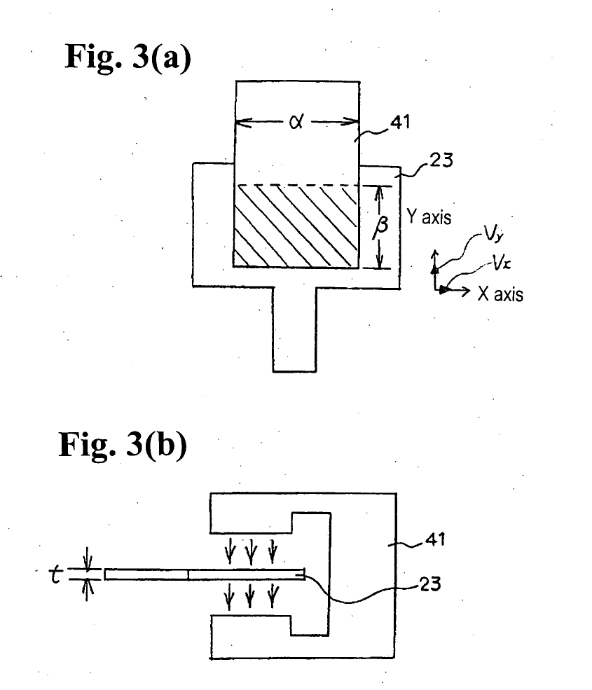

As illustrated in FIGS. 3(a) and 3(b), when the kinetic velocity of the aforementioned conductive plate 23 in the X-axis direction is Vₓ, the kinetic velocity of the same in the Y-axis direction is V_{y}, the length in the X-axis direction of the shaded magnetic field area of the magnetic field generator 41 is α, the length in the Y-axis of the same is β, the thickness of the conductive plate is t, and the density is ρ, the aforementioned conductive plate 23, which is placed in the magnetic field with flux density B₁ in the direction indicated by the arrows, receives braking force Dₓ in the magnitude expressed by the following, formula (2) relative to the movement of the aforementioned balance beam 26A in the longitudinal direction (X-axis direction):
Dₓ=(CoB₁²tαβ/ρ)Vₓ (2)

The aforementioned Co is 0.5 when α/β=1, and increases from 0 to 1 with monotonous regularity as α/β decreases.

Moreover, the aforementioned conductive plate 23 receives braking force D_{y} expressed by the following formula (3) relative to the movement in the Y-axis direction:
D_{y}=(CoB₁²tαβ/ρ)V_{y} (3)

In this case, the aforementioned Co is 0.5: when α/β=1, and increases from 0 to 1 with monotonous regularity as α/β increases. Since the electronic balances are generally affected by vibration in the Y-axis direction more than that in the longitudinal direction (X-axis direction), the magnetic field generator should desirably be shaped so that α/β would be a value greater than 1. Moreover, the breaking force itself is proportional to flux density B1. Accordingly, a large braking force can be obtained by using a permanent magnet having high magnetic permeability, such as a rare earth cobalt magnet.

When external vibration is transmitted to the electronic balance using the balance beam 26A provided with the aforementioned magnet damper 4, the braking force expressed by formula (2) is applied to the vibration transmitted in the longitudinal direction (X-axis direction) of the aforementioned balance beam 26A to thereby control the movement in the X-axis direction, and the braking force expressed by formula (3) is applied to the vibration transmitted in the Y-axis direction to thereby control the movement in the Y-axis direction. Since the effect of external vibration is reduced in terms of the Z-axis direction owing to the balancing function of the electromagnetic force balancing system shown in formula (1) and the filtering process within the aforementioned display unit 3, the electronic balance maintains a high level of accuracy in a stable manner.

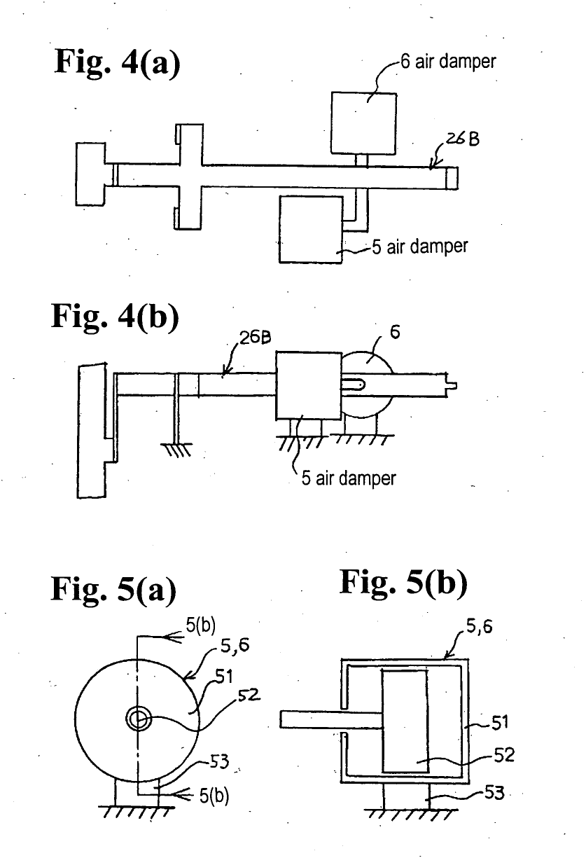

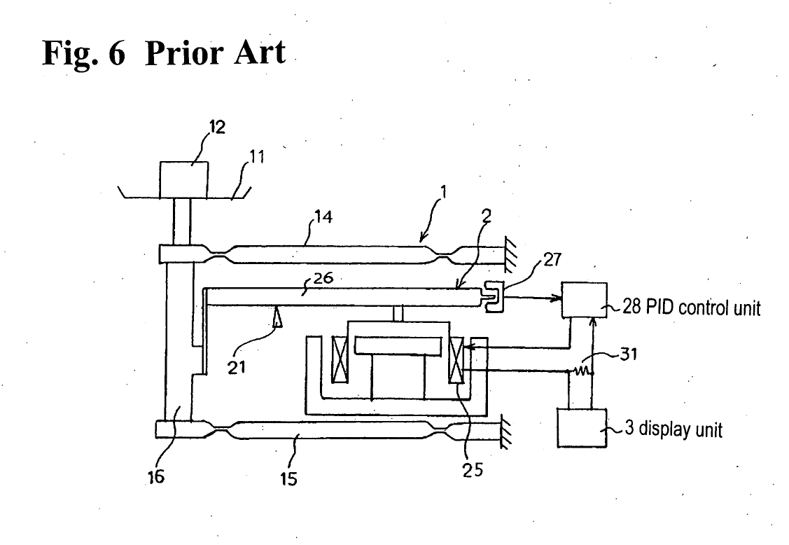

FIG. 4(a) is a plan view and FIG. 4(b) is a side view of the balance beam 26B which uses air dampers 5 and 6 in place of the aforementioned magnet damper 4. The balance beam 26B is provided with the air damper 5 to control the longitudinal vibration and the air damper 6 to control the horizontal vibration that intersects the longitudinal direction at right angles. The aforementioned air dampers 5 and 6, as shown in FIGS. 5(a) and 5(b), are constructed with an axially moving piston 52 inserted within a cylindrical container 51 having amounting stand 53 attached thereunder. A piston 52 is fixed to the balance beam 26B shown in FIGS. 4(a) and 4(b). When external vibration is transmitted to the piston 52, the piston 52 axially moves back and forth to compress air within the aforementioned cylindrical container 51. Braking force is generated by the compressive movements.

The electronic balance according to the present invention is constructed as above and is capable of controlling the horizontal vibration by providing the balance beam 26A with the magnet damper 4, or the balance beam 26B with the air dampers 5 and 6. The present invention, however, is not limited to the constructions shown in these embodiments. For example, to achieve the balance of the aforementioned balance beam 26A more effectively, the aforementioned conductive plate 23 may be disposed on both sides. Alternatively, a magnet damper having a powerful braking force against vibration in the X-axis direction and another magnet damper having a powerful braking force against vibration in the Y-axis direction may be disposed on one balance beam. Moreover, the effect of vibration can be eliminated with a greater braking force by providing both the magnet damper and air damper.

The disclosure of Japanese Patent Application No. 2004-083016 filed on Mar. 22, 2004 is incorporated herein.

While the invention has been explained with reference to the specific embodiments of the invention, the explanation is illustrative, and the invention is limited only by the appended claims.

1. An electronic balance comprising:
a load transmission mechanism for receiving an object to be measured,
a magnetic field generator having a force coil for generating magnetic field,
a balance beam connected at one end to the load transmission mechanism and disposed adjacent to the magnetic field generator with a fulcrum interposed between a portion connected to the weight section and the magnetic field generator, an electromagnetic force generated by supplying current to the force coil being applied to the balance beam to obtain a weight of the object from the current flowing through the force coil in equilibrium with the load, and
a damper attached to the balance beam to control vibration in at least one of a longitudinal direction of the balance beam and a horizontal direction perpendicularly intersecting therewith.

2. An electronic balance according to claim 1, wherein said damper is a magnet damper or air damper.

3. An electronic balance according to claim 1, wherein said balance beam further includes two spring members arranged parallel to each other and attached to a middle portion of the balance beam to form the fulcrum.

4. An electronic balance according to claim 3, wherein said magnetic field generator includes a permanent magnet, said force coil being disposed in a magnetic field of the permanent magnet.

5. An electronic balance according to claim 4, wherein said load transmission mechanism includes a pan to receive the object thereon, a movable column attached to the pan to move vertically and connected to the balance beam, and two beams attached to the movable column.
